(19) United States
(12) Patent Application Publication
(10) Pub. No.: US 2026/0222343 A1
(43) Pub. Date: Jul. 30, 2026

(54) BYPASSING ROOT NODE COMMUNICATIONS IN A WIRELESS NETWORK

(71) Applicant: Silicon Laboratories Inc., Austin, TX (US)

(72) Inventor: Thibaut Colin, Cesson-Sévigné (FR)

(21) Appl. No.: 18/959,805

(22) Filed: Nov. 26, 2024

(51) Int. Cl. H04L 45/74

(52) U.S. Cl. CPC H04L 45/742

(57) ABSTRACT

In one aspect, a method includes: receiving, in a first wireless device of a wireless network configured in a non-storing mode, a message directed to a destination node of the wireless network; updating header information of the message based on routing information obtained from an entry of a cache memory of the first wireless device, the entry associated with the destination node; and forwarding the message towards the destination node on a downstream path that bypasses a root node of the wireless network.

### BACKGROUND

There are many different types of wireless networks in which wireless devices can communicate. One network topology in which Internet-connected devices such as Internet of Things (IoT) devices can communicate is a Routing Protocol for Low Power and Lossy Networks (RPL). In an RPL network, a tree-like routing topology called a Destination Oriented Directed Acyclic Graph (DODAG) is created in which a single node is called the root node. Each device or node acts as a router to pass messages to a next node on a path towards the root node, which may be implemented as a border router.

Especially when used with IoT devices, which may be resource-constrained devices, an RPL network is typically configured in a non-storing mode, in which the individual devices do not have sufficient routing information to direct messages to a destination. Instead, all messages originating from one device to another device first transit to the tree's root, before being sent to the destination device. Only this root knows how to contact every network device.

Thus an RPL network in non-storing mode optimizes upstream communications from leaf nodes to the DODAG root, and seeks to minimize the information stored on every non-root device. However, this configuration adversely impacts communication latency, as all messages first are sent to the root node before being sent to a destination node. This arrangement also increases traffic, especially in the area of the root node.

### SUMMARY OF INVENTION

In one aspect, a method includes: receiving, in a first wireless device of a wireless network configured in a non-storing mode, a message directed to a destination node of the wireless network; updating header information of the message based on routing information obtained from an entry of a cache memory of the first wireless device, the entry associated with the destination node; and forwarding the message towards the destination node on a downstream path that bypasses a root node of the wireless network.

In an implementation, the method further comprises identifying the destination node for inclusion in the cache memory. The method may also include identifying the destination node for the inclusion in the cache memory based at least in part on a frequency of messages received in the first wireless device that are directed to the destination node.

In one implementation, the method may also include, in response to identifying the destination node for the inclusion in the cache memory: obtaining the routing information from a downstream message; and storing the routing information into the entry of the cache memory. The method may also include obtaining the routing information from at least a portion of a source routing header included in the downstream message by the root node.

In one implementation, the method further comprises maintaining statistical information regarding messages directed to the destination node. The method may also include identifying the destination node for the inclusion in the cache memory based at least in part on the statistical information.

In an implementation, the method further includes receiving the message from a child node coupled to a source node, and forwarding the message towards the destination node, the message comprising a node-to-node communication between the source node comprising a first Internet of Things (IoT) device and the destination node comprising a second IoT device. The method may also include receiving the message comprising the node-to-node communication, the message comprising sensor information of the first IoT device, and in response to the sensor information of the first IoT device, the second IoT device is to perform an operation. Forwarding the message towards the destination node on the downstream path that bypasses the root node of the wireless network reduces a number of nodes of the wireless network that the message traverses between the first IoT device and the second IoT device.

In one implementation, the method further comprises reducing message traffic towards the root node based at least in part on re-routing, by the first wireless device, a plurality of messages directed towards the destination node along the downstream path that bypasses the root node.

In another aspect, an apparatus includes: at least one processor to execute instructions; a cache memory coupled to the at least one processor, the cache memory to store a plurality of entries, each of the plurality of entries associated with a destination node of a wireless network and comprising routing information to provide a routing path from the apparatus to the destination node; and a radio frequency (RF) circuit coupled to the at least one processor, the RF circuit to transmit and receive RF signals within the wireless network, the wireless network configured for a non-storing mode. The apparatus is configured to: receive a message directed to a first destination node of the wireless network; update header information of the message based on routing information obtained from an entry of the cache memory associated with the first destination node; and forward, using the updated header information, the message towards the first destination node on a path that bypasses a root node of the wireless network.

In an implementation the cache memory comprises a bypass cache memory to store the entries having the routing information obtained from a source routing header of a given message received in the apparatus. The apparatus may include a non-volatile storage to store a Wireless-Smart Ubiquitous Network (Wi-SUN) protocol stack, the Wi-SUN protocol stack comprising a plurality of instructions to cause the apparatus to maintain the cache memory. The apparatus may further include an application programming interface to enable a user to provide configuration information for the cache memory, where the configuration information comprises at least one of a size of the cache memory or a lifetime of an entry in the cache memory.

In one implementation, the apparatus is to: receive, from a parent node, a second message directed to the first destination node; and update statistical information stored in the entry of the cache memory associated with the first destination node based on the receipt of the second message. The apparatus may be configured to store the routing information in the entry of the cache memory associated with the first destination node based at least in part on a frequency of messages received in the apparatus that are directed to the first destination node.

In yet another aspect, a method comprises: receiving a message directed to a destination node of a wireless network configured in a non-storing mode; updating header information of the message based on routing information obtained from an entry of a cache memory of the wireless device, the entry associated with the destination node; and forwarding the message towards the destination node on a downstream path that bypasses a root node of the wireless network.

In one implementation, the method further includes identifying the destination node for inclusion in the cache memory based at least in part on a frequency of messages received in the wireless device that are directed to the destination node. The method may also include after identifying the destination node for the inclusion in the cache memory: obtaining the routing information from a header of a downstream message directed to the destination node; and storing the routing information into the entry of the cache memory.

### BRIEF DESCRIPTION OF THE DRAWINGS

FIG. 1 is a network tree diagram showing a plurality of routers in accordance with an embodiment.

FIG. 2 is a flow diagram of a method in accordance with an embodiment.

FIG. 3 is a flow diagram of a method in accordance with another embodiment.

FIG. 4 is a flow diagram of a method in accordance with yet another embodiment.

FIG. 5 is a block diagram of a representative integrated circuit in accordance with an embodiment.

FIG. 6 is a high level diagram of a network in accordance with an embodiment.

### DETAILED DESCRIPTION

In various embodiments, a wireless network that is configured in a non-storing mode can provide a limited amount of routing information storage in one or more nodes within the network. As used herein, the terms “node” and “router” are used interchangeably and are intended to refer to a device such as a wireless device that includes routing circuitry and/or capabilities to perform the routing of messages within the network.

With routing information available to a router, the router can cause a message directed from a source node to a destination node to bypass communication to the root node. More specifically, embodiments provide techniques to enable one or more intermediate nodes in a network to identify messages directed to a destination node for which it stores routing information. In turn, such intermediate node can bypass communication of the message to the root node, and instead direct the message to the destination node on a shorter bypass path.

In this way, embodiments can help minimize node-to-node latency while maintaining a relatively low impact on memory and without adding any extra messaging. Still further with embodiments, traffic density around a border router (e.g., root node) can be reduced, by redirecting messages away from the root node, on an updated route to a destination node that avoids the root node.

Without an embodiment, in an RPL or other wireless network operating in a non-storing mode every message sent from one non-root node to another non-root node is first sent to the DODAG root and then retransmitted to the destination node. In a first phase of message communication when the message is sent to the root node, the message includes header information to identify the direction of the message (upwards, to the root) and the address of the destination node. During that first phase, the message payload is encapsulated into two headers (e.g., IPv6 headers). A first header (which may be an outer header) contains a source field having the address of the initial source router and a destination field having the address of the next upward router. A second header (which may be an inner header) contains a source field having the address of the initial source router and a destination field having the address of the destination router. The first header is updated as the message traverses upward to the root node. In a second phase, when sent to the destination node beginning from the root node, the message has a headier that identifies the direction of the message (downwards, to the destination node) and an ordered list of routers to contact to reach the destination node. This ordered list is referred to as a source routing header (SRH).

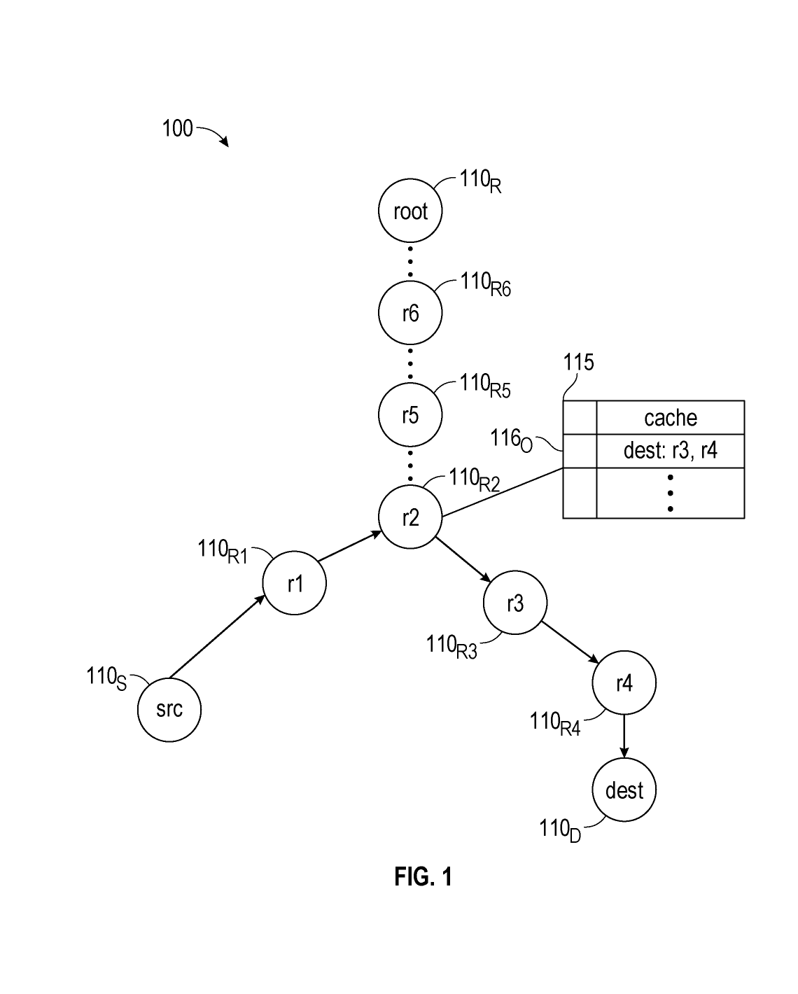

Referring to FIG. 1, shown is a network tree diagram showing a plurality of routers. As shown in FIG. 1, a RPL network has a plurality of nodes 110_{D, R1-R6, RN, S}, including a root node 110_{RN} and a plurality of routers 110_{R1-R4}, via which a source node 110_{S} (src) and a destination node 110_{D} (dest) are coupled. Without an embodiment, 7 transmissions are required to send a message to destination node 110_{D} from source node 110_{S}. Note however that the number of hops between src and dest illustrated in FIG. 1 is rather short and can be significantly larger.

With embodiments, a wireless network operating in a non-storing mode provides a capability for at least certain routers to store routing information, and use this information to bypass communication of at least certain messages to root node 110_{RN}. As shown in FIG. 1, a cache memory 115 or other storage included in router 110_{R2} can store routing information received from the root. In one or more embodiments, cache memory 115 is implemented as a bypass cache memory and includes a plurality of entries 116 configured to store various information, including: statistics used to activate optimization; and routing information that is used to bypass the root. In the particular implementation shown, cache memory 115 stores an entry 116₀ associated with destination node 110_{D}, and which includes routing information to route messages directed to destination node 110_{D}.

In operation, in an initial state, cache memory 115 is empty. Based on multiple messages sent from src to dest, router 110_{R2} detects that this specific route appears to be used often. Based on this determination, router 110_{R2} maintains routing information to reach destination node 110_{D}, bypassing root node 110_{RN}. In the topology of FIG. 1, bypassing root node 110_{RN} reduces the number of transmissions to send a message to destination node 110_{D} from source node 110_{S} from 7 to 5.

In embodiments, when receiving a message from a child node, router 110_{R2} (or any other configured router): inspects the message's final destination (e.g., by reading the IPv6 inner header destination); compares the final destination with the content of its bypass cache; if the destination does not include an entry in the cache, forwards the packet to the next upward router; and instead if the destination is in the cache and a route is known, a new SRH is formed and the message is directed to the next downward hop on the way to the destination node, bypassing the root node.

When receiving a message from a parent node, router 110_{R2} (or any other configured router): inspects the message's final destination; and compares the final destination with the content of its bypass cache; if the destination is not known, the router 110_{R2} may consider adding a new entry in the cache; and if the destination is known, statistics in the cache memory for the associated destination are updated.

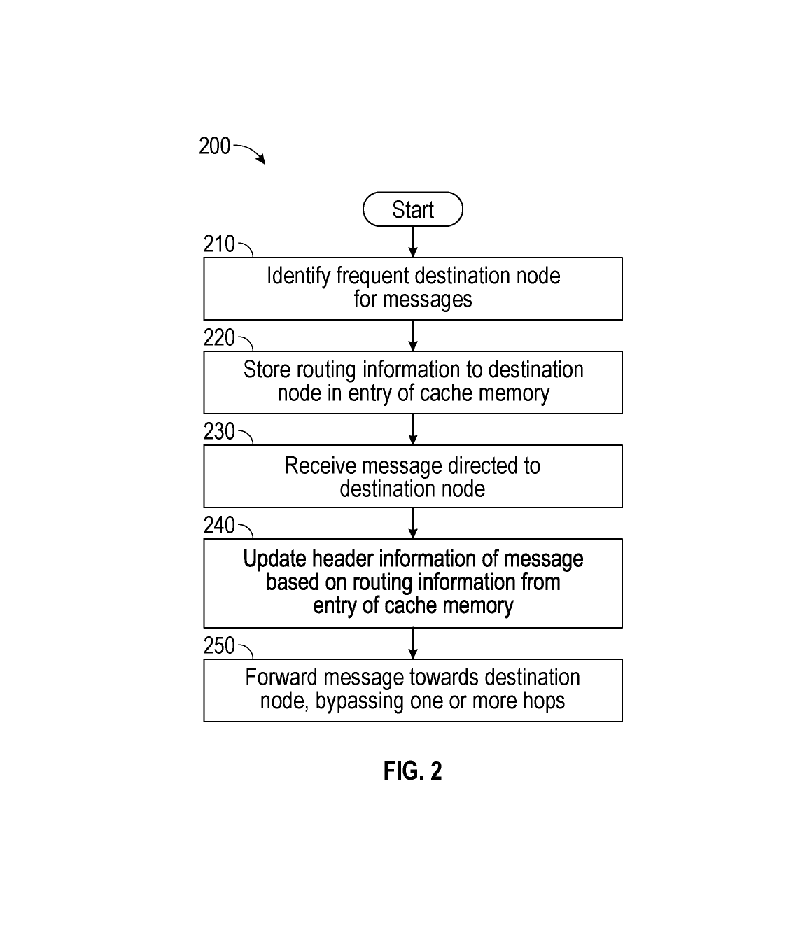

Referring now to FIG. 2, shown is a flow diagram of a method in accordance with an embodiment. As shown in FIG. 2, method 200 is a method for bypassing communications to a root node, as described herein. In various implementations, one or more routers in an RPL network may be configured with hardware circuitry, firmware, and/or software, and/or combinations thereof, to perform such bypassed communications when the RPL network is configured in a non-storing mode. In one or more implementations, the hardware circuitry may execute firmware instructions of a given wireless protocol stack that are stored in a non-transitory storage medium, e.g., a flash memory.

As shown in FIG. 2, method 200 begins by identifying a frequent destination node for messages (block 210). In different implementations, a router may maintain a temporary storage such as a scratchpad cache memory or other temporary storage to store information regarding destination nodes of incoming messages and corresponding counts for messages to the given destination nodes. When a given number of messages directed to the same destination node meets some threshold level, this identification of a frequent destination can be met.

In this instance, control passes to block 220 where the router can store routing information to this destination node in an entry of a cache memory of the router. Although embodiments are not limited in this aspect, the cache memory may be configured with a given number of entries, each to be associated with a destination node. Each entry may include various information, including routing information, statistical information and so forth. In one or more embodiments, this routing information may be obtained from an SRH of a downward message from the root node to the destination node. This routing information provides a listing of all nodes through which the message is to be routed between this router and the destination node. In one or more embodiments, the statistical information may include a count of messages directed to this destination node and/or recency information to indicate when a most recent message has been directed to the destination node (e.g., in the form of time elapsed since this most recent message).

At this point, the router is adequately configured to perform bypassed communications, such that incoming messages to the router (in an upstream direction toward the root node) can be re-routed to bypass the root node communication and be delivered on a more efficient path to the destination node.

As further illustrated in FIG. 2, the router, at block 230, receives a message directed to the destination node. Understand that in this instance, the message is traversing in an upward direction during a first phase of communication to the root node. Then, at block 240, the router updates header information of the message based on the routing information stored in the cache memory. Then based on this updated routing information the router, at block 250, forwards the message towards the destination node, bypassing one or more hops (including the root node). Although shown at this high level in the embodiment of FIG. 2, many variations and alternatives are possible.

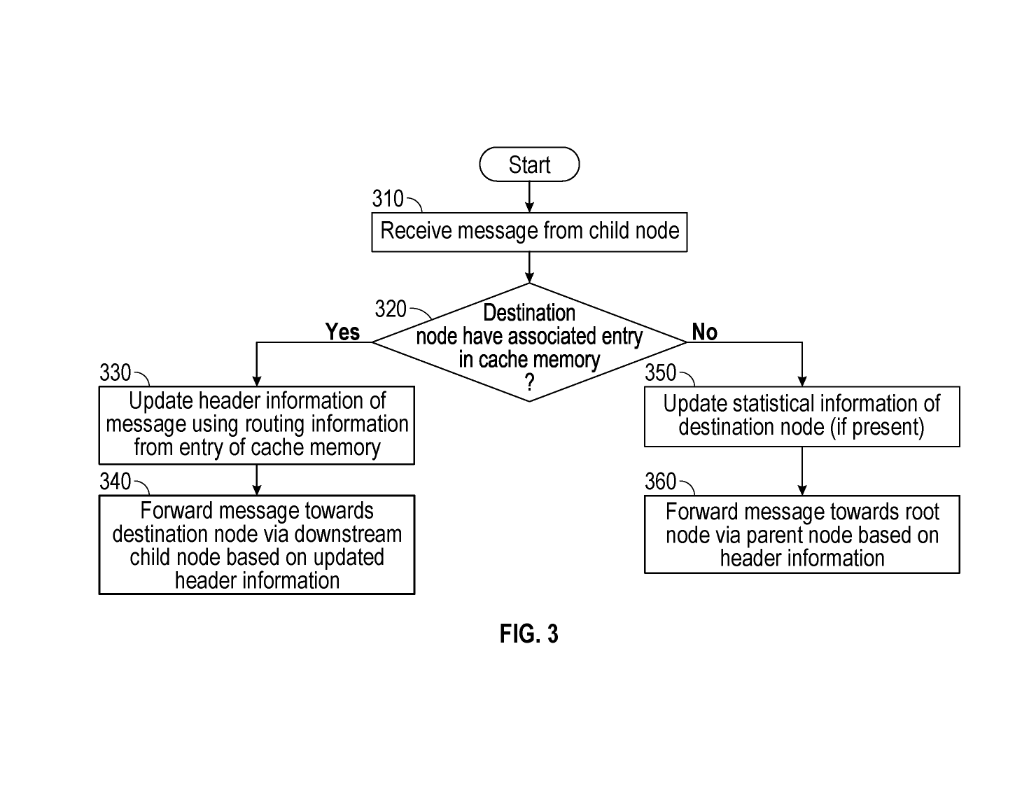

Referring now to FIG. 3, shown is a flow diagram of a method in accordance with another embodiment. As shown in FIG. 3, method 300 is a method for bypassing communications received in a router (having hardware, firmware, and/or software as described herein) from a child node.

As shown, method 300 begins by receiving a message from a child node (block 310). The router may, based on a header of this received message, determine whether a destination node of the message has an associated entry within a bypass cache of the router (diamond 320). If so, control passes to block 330, where header information of the message is updated. More specifically, the router may obtain routing information from the stored entry in the bypass cache and append it as an updated header to the message. Understand that this routing information provides a listing of nodes in a downstream direction from the router to the destination node. With this information, at block 340, the router forwards the message towards the destination node via a downstream child node. This message thus traverses towards the destination node on a path that bypasses the root node, based on the updated header information now included in the message.

Still referring to FIG. 3, if the destination node does not have an associated entry in the bypass cache, control passes to block 350, where, if present, statistical information of the destination node can be updated. For example, the router may maintain scratchpad storage of incoming messages to identify whether a given destination node is a frequent target of messages (and thus may benefit from populating routing information into the bypass cache).

Finally, at block 360, for the situation in which the router does not have cached routing information for the destination node, the message is forwarded along towards the root node via a parent node of the router. This routing upwards towards the root node is based on the header information of the message, since the router cannot update the header information, since it lacks routing information included in an entry in its bypass cache for the destination node. Thus in this instance, the message traverses upwardly to the root node, and then downwardly to the destination node. Although shown at this high level in the embodiment of FIG. 3, many variations and alternatives are possible.

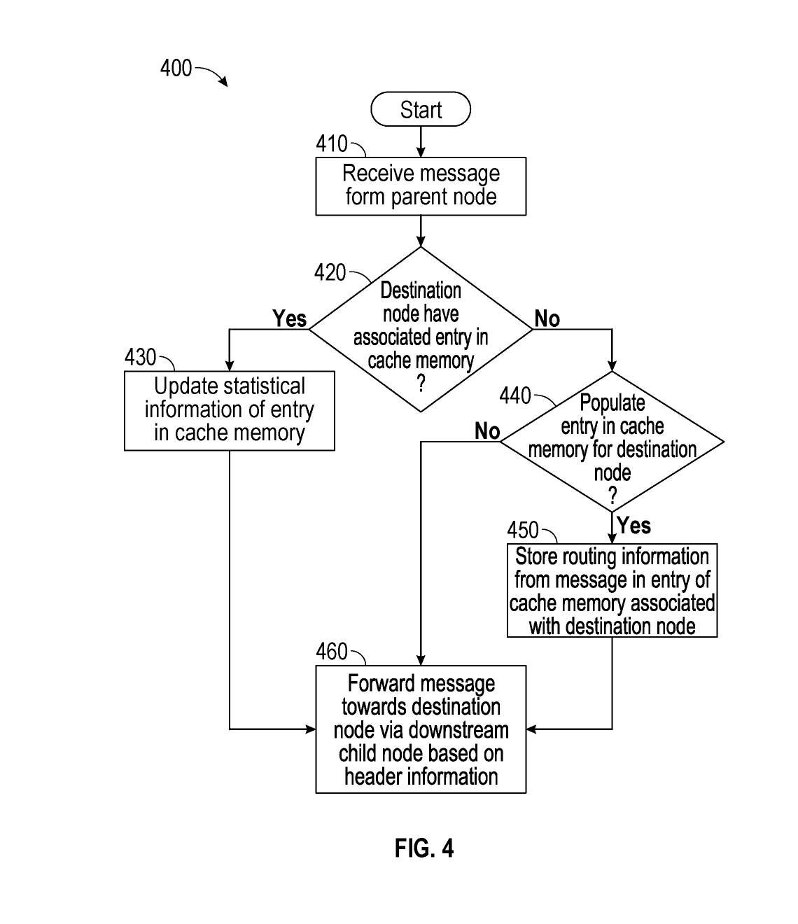

Referring now to FIG. 4, shown is a flow diagram of a method in accordance with yet another embodiment. As shown in FIG. 4, method 400 is a method for handling a communication received in a router (having hardware, firmware, and/or software as described herein) from a parent node.

As shown, method 400 begins by receiving a message from a parent node (block 410). The router may, based on a header of this received message, determine whether a destination node of the message has an associated entry within a bypass cache of the router (diamond 420). If so, control passes to block 430, where statistical information in the entry of the bypass cache may be updated. In one or more embodiments, this statistical information may include one or more of count information (regarding the number of received messages directed to the destination node), other frequency information and/or time stamp information. Control then passes to block 460, where the router forwards the message towards the destination node via a downstream child node. This message traverses towards the destination node on a path indicated by the SRH included in the header of the message (e.g., from a root node or a parent node).

Still referring to FIG. 4, instead if it is determined that the destination node does not have an associated entry in the cache memory, control passes to diamond 440. At block 440, the router may determine whether to populate an entry in the cache memory for the destination node. There may be various considerations made in order to determine whether to populate a cache entry. In one implementation, if the router has seen a given number of messages directed to the destination node (e.g., that exceeds a threshold number), the router may determine to populate an entry for this destination node.

In this case, control passes from diamond 440 to block 450. At block 450, the router can store routing information from the message into an entry in the cache memory associated with this destination node. As described above, this downstream message includes an SRH that provides a list of nodes on the path to the destination node. This information may be populated into the entry as the routing information. Next, control passes to block 460, described above, where the message is forwarded downwardly towards the destination node. Also, if it is determined not to populate an entry in the cache memory for the destination node, control passes directly to block 460 from diamond 440. Although shown at this high level in the embodiment of FIG. 4, many variations and alternatives are possible.

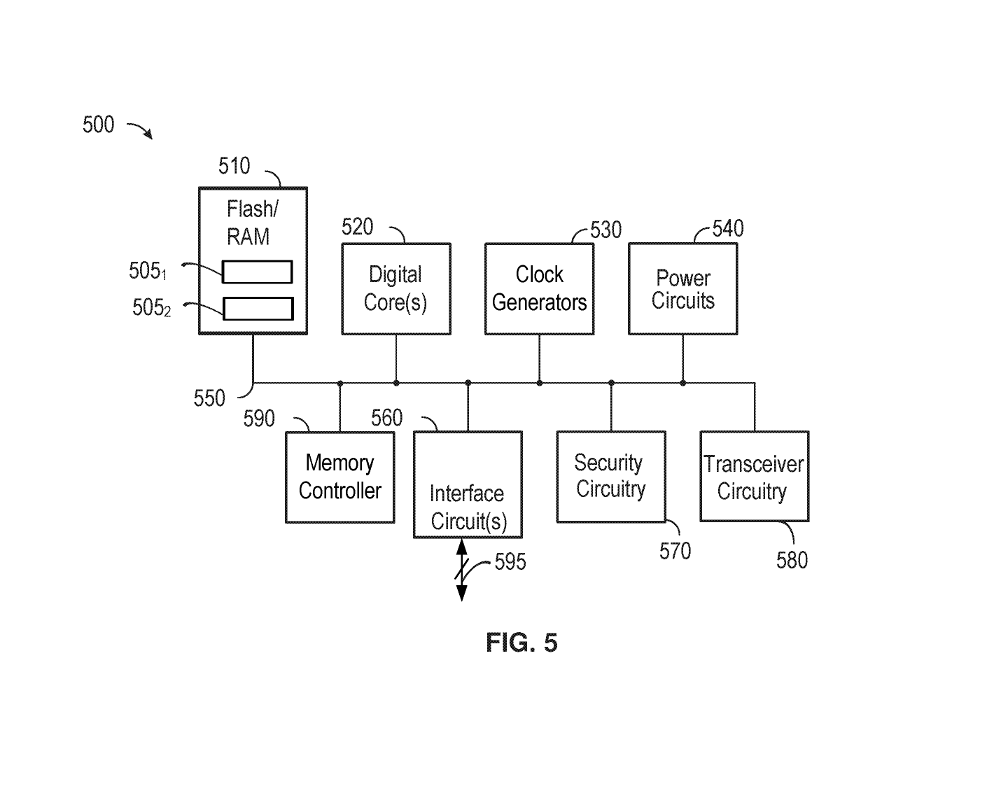

Referring now to FIG. 5, shown is a block diagram of a representative integrated circuit 500 that includes routing circuitry that can leverage routing information stored in a bypass cache memory to re-direct incoming messages on a downward path to a destination node, bypassing a root node and potentially other nodes, as described herein. In the embodiment shown in FIG. 5, integrated circuit 500 may be, e.g., a multi-mode wireless transceiver that may operate according to one or more wireless protocols (e.g., Matter and Zigbee, Wi-SUN, among others) or other device that can be used in a variety of use cases. In one or more embodiments, the circuitry of integrated circuit 500 shown in FIG. 5 may be implemented on a single semiconductor die or implemented on separate dies for wireless communication, MCU compute, external flash and/or other IP blocks.

Integrated circuit 500 may be included in a range of devices, but for purposes of discussion, it may be incorporated into an IoT device as described herein. In the embodiment shown, integrated circuit 500 includes a memory system 510 which in an embodiment may include volatile storage, such as RAM and non-volatile memory such as a flash memory. The flash memory is a non-transitory storage medium that can store instructions and data. In embodiments, this storage may store code 505₁for a Wi-SUN protocol stack, which may include instructions for generating and maintaining a bypass cache memory and using its routing information to re-route messages on a bypass path to a destination node, as described herein. Note that code 505₁also may include one or more application programming interfaces to expose the bypassed communication capability to a user (e.g., a manufacturer of IoT devices) and enable the user to configure the bypass cache memory (e.g., a number of entries and a duration or lifetime of such entries within the cache). As further shown, memory 510 includes a cache memory 505₂, e.g., implemented in the RAM, which may store entries associated with various destination nodes as described herein. Integrated circuit 500 also may include a memory controller 590.

Memory system 510 couples via a bus 550 to one or more digital cores 520, which may include one or more cores and/or microcontrollers that act as processing units of the integrated circuit, and which may execute an IoT end device application to control circuitry of the IoT device. Digital cores 520 may further include routing circuitry to re-route messages as described herein. Digital cores 520 may couple to clock generators 530 which may provide one or more phase locked loops or other clock generator circuitry to generate various clocks for use by circuitry of the IC.

As further illustrated, IC 500 further includes power circuitry 540. Additional circuitry may be present depending on particular implementation to provide various functionality and interaction with external devices. Such circuitry may include interface circuitry 560 which provides a digital communication interface with additional circuitry via a link 595. IC 500 also may include security circuitry 570 to perform wireless security techniques.

In addition, as shown in FIG. 5, transceiver circuitry 580 may be provided to enable transmission and reception of wireless signals, e.g., according to one or more of a local area or wide area wireless communication scheme, such as Matter, Zigbee, Bluetooth, IEEE 802.11, IEEE 802.15.4, cellular communication or so forth. Understand while shown with this high level view, many variations and alternatives are possible.

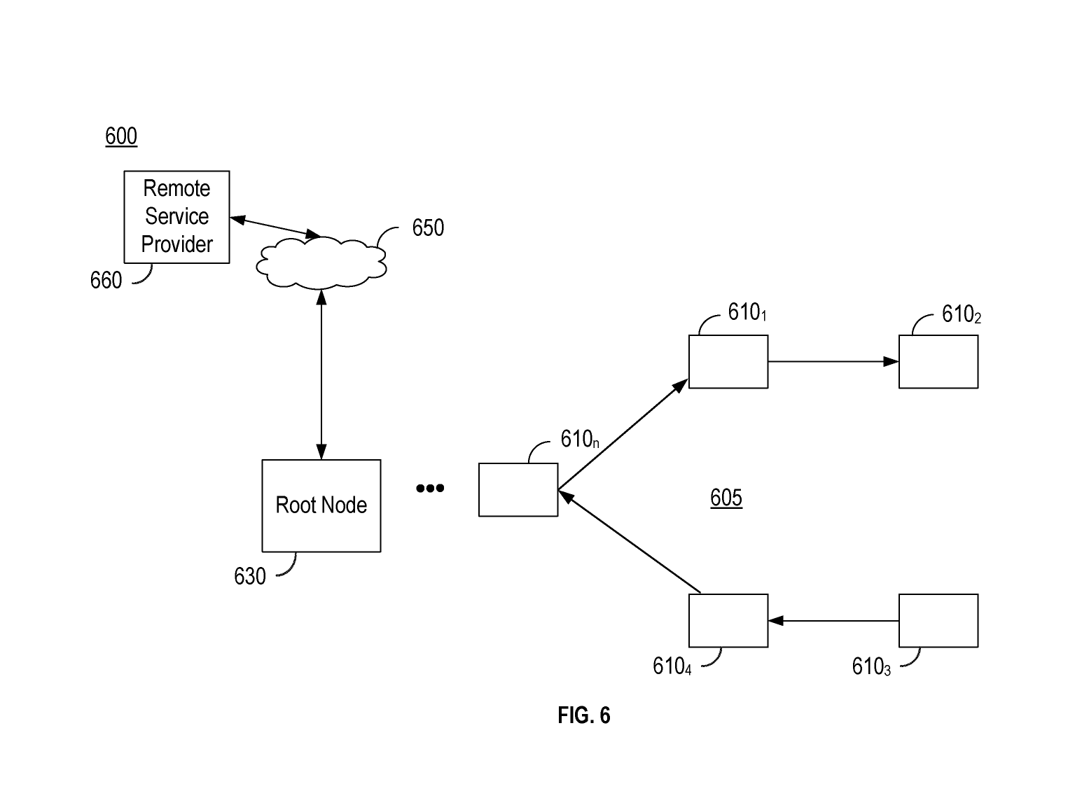

ICs such as described herein may be implemented in a variety of different devices as described above. Referring now to FIG. 6, shown is a high level diagram of a network in accordance with an embodiment. As shown in FIG. 6, a network 600 includes a variety of devices, including IoT devices which may include routers as described herein, access points and remote service providers.

In the embodiment of FIG. 6, a wireless mesh network 605 is present, e.g., in an environment having multiple wireless devices 610₀₋ₙ. In an embodiment, network 605 may be an outdoor Wi-SUN field area network (FAN) that is configured as an RPL network in a non-storing mode, to reduce resource usage in the individual devices.

As shown, wireless devices 610, which may be representative versions of nodes 110 of FIG. 1, couple to a root node 630 (which may be implemented as a border router) that in turn communicates with a remote service provider 660 via a wide area network 650, e.g., the Internet. In some cases, root node 630 may be a smart pole that provides various functionality for network 600. Understand while shown at this high level in the embodiment of FIG. 6, many variations and alternatives are possible.

As one particular example, wireless devices 610 may be smart lights, with at least some of these lights configured with routers to perform the bypassed communications as described herein. For example, a first node 610₁may be a smart light located at a first end of a road. When first node 610₁detects (e.g., via a sensor) activity (e.g., a pedestrian, vehicle or so forth), it may light up and communicate this activity detection to one or more destination nodes 610, including for purposes of discussion destination node 610₂, which may be a smart light located at a second end of the road. With an embodiment, such communications can avoid being sent to root node 630, and instead, an intermediary node 610ₙ can re-route the communications on a downward path to destination node 610₂.

Of course, other use cases are possible. For example, bypassed communications may occur in an indoor communication scenario, such as more efficiently communicating between a switch and a light without needing to traverse to a root node.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
receiving, in a first wireless device of a wireless network configured in a non-storing mode, a message directed to a destination node of the wireless network;
updating header information of the message based on routing information obtained from an entry of a cache memory of the first wireless device, the entry associated with the destination node; and
forwarding the message towards the destination node on a downstream path that bypasses a root node of the wireless network.

2. The method of claim 1, further comprising identifying the destination node for inclusion in the cache memory.

3. The method of claim 2, further comprising identifying the destination node for the inclusion in the cache memory based at least in part on a frequency of messages received in the first wireless device that are directed to the destination node.

4. The method of claim 2, further comprising, in response to identifying the destination node for the inclusion in the cache memory:
obtaining the routing information from a downstream message; and
storing the routing information into the entry of the cache memory.

5. The method of claim 4, further comprising obtaining the routing information from at least a portion of a source routing header included in the downstream message by the root node.

6. The method of claim 2, further comprising maintaining statistical information regarding messages directed to the destination node.

7. The method of claim 6, further comprising identifying the destination node for the inclusion in the cache memory based at least in part on the statistical information.

8. The method of claim 1, further comprising receiving the message from a child node coupled to a source node, and forwarding the message towards the destination node, the message comprising a node-to-node communication between the source node comprising a first Internet of Things (IoT) device and the destination node comprising a second IoT device.

9. The method of claim 8, further comprising receiving the message comprising the node-to-node communication, the message comprising sensor information of the first IoT device, wherein in response to the sensor information of the first IoT device, the second IoT device is to perform an operation.

10. The method of claim 8, wherein forwarding the message towards the destination node on the downstream path that bypasses the root node of the wireless network reduces a number of nodes of the wireless network that the message traverses between the first IoT device and the second IoT device.

11. The method of claim 1, further comprising reducing message traffic towards the root node based at least in part on re-routing, by the first wireless device, a plurality of messages directed towards the destination node along the downstream path that bypasses the root node.

12. An apparatus comprising:
at least one processor to execute instructions;
a cache memory coupled to the at least one processor, the cache memory to store a plurality of entries, each of the plurality of entries associated with a destination node of a wireless network and comprising routing information to provide a routing path from the apparatus to the destination node; and
a radio frequency (RF) circuit coupled to the at least one processor, the RF circuit to transmit and receive RF signals within the wireless network, the wireless network configured for a non-storing mode,
wherein the apparatus is to:
receive a message directed to a first destination node of the wireless network;
update header information of the message based on routing information obtained from an entry of the cache memory associated with the first destination node; and
forward, using the updated header information, the message towards the first destination node on a path that bypasses a root node of the wireless network.

13. The apparatus of claim 12, wherein the cache memory comprises a bypass cache memory to store the entries having the routing information obtained from a source routing header of a given message received in the apparatus.

14. The apparatus of claim 12, further comprising a non-volatile storage to store a Wireless-Smart Ubiquitous Network (Wi-SUN) protocol stack, the Wi-SUN protocol stack comprising a plurality of instructions to cause the apparatus to maintain the cache memory.

15. The apparatus of claim 14, further comprising an application programming interface to enable a user to provide configuration information for the cache memory, wherein the configuration information comprises at least one of a size of the cache memory or a lifetime of an entry in the cache memory.

16. The apparatus of claim 12, wherein the apparatus is to:
receive, from a parent node, a second message directed to the first destination node; and
update statistical information stored in the entry of the cache memory associated with the first destination node based on the receipt of the second message.

17. The apparatus of claim 12, wherein the apparatus is to store the routing information in the entry of the cache memory associated with the first destination node based at least in part on a frequency of messages received in the apparatus that are directed to the first destination node.

18. A computer-readable medium comprising instructions that when executed by at least one processor of a wireless device cause the wireless device to perform a method comprising:
receiving a message directed to a destination node of a wireless network configured in a non-storing mode;
updating header information of the message based on routing information obtained from an entry of a cache memory of the wireless device, the entry associated with the destination node; and
forwarding the message towards the destination node on a downstream path that bypasses a root node of the wireless network.

19. The computer readable medium of claim 18, wherein the method further comprises identifying the destination node for inclusion in the cache memory based at least in part on a frequency of messages received in the wireless device that are directed to the destination node.

20. The computer readable medium of claim 19, wherein the method further comprises after identifying the destination node for the inclusion in the cache memory:
obtaining the routing information from a header of a downstream message directed to the destination node; and
storing the routing information into the entry of the cache memory.
